(19) United States
(12) Patent Application Publication
(10) Pub. No.: US 2021/0185352 A1
(43) Pub. Date: Jun. 17, 2021

(54) VIDEO ENCODER, VIDEO DECODER, VIDEO ENCODING METHOD, VIDEO DECODING METHOD

(71) Applicant: Mitsubishi Electric Corporation, Tokyo (JP)

(72) Inventors: Hari KALVA, Boca Raton, FL (US); Borivoje FURHT, Boca Raton, FL (US)

(73) Assignee: Mitsubishi Electric Corporation, Tokyo (JP)

(21) Appl. No.: 17/257,363

(22) PCT Filed: Jul. 2, 2019
(86) PCT No.: PCT/US19/40311

§ 371 Date: Dec. 31, 2020

Related U.S. Application Data
(60) Provisional application No. 62/694,524, filed on Jul. 6, 2018.
(60) Provisional application No. 62/694,540, filed on Jul. 6, 2018.

(51) Int. Cl. H04N 19/577; H04N 19/176; H04N 19/126; H04N 19/96; H04N 19/91

(52) U.S. Cl. CPC H04N 19/577; H04N 19/176; H04N 19/91; H04N 19/96; H04N 19/126

(57) ABSTRACT

A method includes receiving a bit stream; determining whether a bi-directional prediction with adaptive weights mode is enabled for a current block; determining at least one weight; and reconstructing pixel data of the current block and using a weighted combination of at least two reference blocks. Related apparatus, systems, techniques and articles are also described.

### CROSS-REFERENCE TO RELATED APPLICATIONS

This application claims priority to U.S. Provisional Patent Application No. 62/694,524 filed Jul. 6, 2018, and to U.S. Provisional Patent Application No. 62/694,540 filed Jul. 6, 2018, the entire contents of each of which are hereby expressly incorporated by reference herein.

### TECHNICAL FIELD

The subject matter described herein relates to video compression including decoding and encoding.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

### SUMMARY

In an aspect, a method includes receiving a bit stream; determining whether a bi-directional prediction with adaptive weights mode is enabled for a current block; determining at least one weight; and reconstructing pixel data of the current block and using a weighted combination of at least two reference blocks.

One or more of the following can be included in any feasible combination. For example, the bit stream can include a parameter indicating whether the bi-directional prediction with adaptive weights mode is enabled for the block. The bi-directional prediction with adaptive weights mode can be signaled in the bit stream. Determining at least one weight can include determining an index into an array of weights; and accessing the array of weights using the index. Determining at least one weight can include determining a first distance from a current frame to a first reference frame of the at least two reference blocks; determining a second distance from the current frame to a second reference frame of the at least two reference blocks; and determining the at least one weight based on the first distance and the second distance. Determining the at least one weight based on the first distance and the second distance can be performed according to: w1=α0×(N_{I})/(N_{I}+N_{J}); w0=(1−w1); where w1 is a first weight, w2 is a second weight, α₀ is a predetermined value; N_{I} is the first distance and N_{J} is the second distance. Determining at least one weight can include: determining a first weight by at least determining an index into an array of weights and accessing the array of weights using the index; and determining a second weight by at least subtracting the first weight from a value. The array can include integer values including {4, 5, 3, 10, −2}. Determining the first weight can include setting a first weight variable w1 to an element of the array specified by the index. Determining the second weight can include setting a second weight variable w0 equal to the value minus the first weight variable. Determining the first weight and determining the second weight can be performed according to: setting a variable w1 equal to bcwWLut[bcwIdx] with bcwWLut[k]={4, 5, 3, 10, −2}; and setting a variable w0 equal to (8−w1); wherein bcwIdx is the index, and k is a variable. The weighted combination of the at least two reference blocks can be computed according to pbSamples[x][y]=Clip3(0, (1<<bitDepth)−1, (w0*predSamplesL0[x][y]+w1*predSamplesL1[x][y]+offset3)>>>(shift2+3)), where pbSambles [x] [y] are prediction pixel values, x and y are luma locations, << is an arithmetic left shift of a two's complement integer representation by binary digits, predSamplesL0 is a first array of pixel values of a first reference block of the at least two reference blocks, predSamplesL1 is a second array of pixel values of a second reference block of the at least two reference blocks, offset3 is an offset value, shift2 is a shift value, and

$$Clip 3 ( x , y , z ) = \{ \begin{matrix}x ; & z < x \\ y ; & z > y \\ z ; & other wise\end{matrix} .$$

Determining the index can include adopting the index from a neighboring block during a merge mode. Adopting the index from the neighboring block during merge mode can include determining a merge candidate list containing spatial candidates and temporal candidates, selecting, using a merge candidate index included in the bit stream, a merge candidate from the merge candidate list, and setting a value of the index to a value of an index associated with the selected merge candidate. The at least two reference blocks can include a first block of prediction samples from a previous frame and a second block of prediction samples from a subsequent frame. Reconstructing pixel data can include using an associated motion vector contained in the bit stream. The reconstructing pixel data can be performed by a decoder including circuitry, the decoder further comprising: an entropy decoder processor configured to receive the bit stream and decode the bit stream into quantized coefficients; an inverse quantization and inverse transformation processor configured to process the quantized coefficients including performing an inverse discrete cosine; a deblocking filter; a frame buffer; and an intra prediction processor. The current block can form part of a quadtree plus binary decision tree. The current block can be a coding tree unit, a coding unit, and/or a prediction unit.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating an example of bi-directional prediction;

FIG. 2 is a process flow diagram illustrating an example decoding process 200 of bi-directional prediction with adaptive weights;

FIG. 3 illustrates example spatial neighbors for a current block;

FIG. 4 is a system block diagram illustrating an example video encoder capable of performing bi-directional prediction with adaptive weight;

FIG. 5 is a system block diagram illustrating an example decoder capable of decoding a bit stream using bi-directional prediction with adaptive weights;

and

FIG. 6 is a block diagram illustrating an example multi-level prediction with adaptive weights based on reference picture distances approach according to some implementations of the current subject matter.

Like reference symbols in the various drawings indicate like elements.

### DETAILED DESCRIPTION

In some implementations, weighted prediction can be improved using adaptive weights. For example, the combination of reference pictures (e.g., the predictor) can be computed using weights, which can be adaptive. One approach to adaptive weights is to adapt the weights based on reference picture distance. Another approach to adaptive weights is to adapt the weights based on neighboring blocks. For example, weights can be adopted from a neighboring block if the current blocks' motion is to be merged with the neighboring block such as in a merge mode. By adaptively determining weights, compression efficiency and bit rate can be improved.

Motion compensation can include an approach to predict a video frame or a portion thereof given the previous and/or future frames by accounting for motion of the camera and/or objects in the video. It can be employed in the encoding and decoding of video data for video compression, for example in the encoding and decoding using the Motion Picture Experts Group (MPEG)-2 (also referred to as advanced video coding (AVC)) standard. Motion compensation can describe a picture in terms of the transformation of a reference picture to the current picture. The reference picture can be previous in time or from the future when compared to the current picture. When images can be accurately synthesized from previously transmitted and/or stored images, the compression efficiency can be improved.

Block partitioning can refer to a method in video coding to find regions of similar motion. Some form of block partitioning can be found in video codec standards including MPEG-2, H.264 (also referred to as AVC or MPEG-4 Part 10), and H.265 (also referred to as High Efficiency Video Coding (HEVC)). In example block partitioning approaches, non-overlapping blocks of a video frame can be partitioned into rectangular sub-blocks to find block partitions that contain pixels with similar motion. This approach can work well when all pixels of a block partition have similar motion. Motion of pixels in a block can be determined relative to previously coded frames.

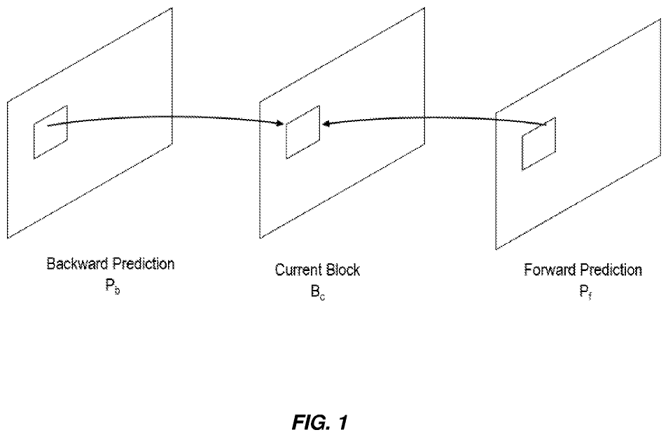

Motion compensated prediction is used in some video coding standards including MPEG-2, H.264/AVC, and H.265/HEVC. In these standards, a predicted block is formed using pixels from a reference frame and the location of such pixels is signaled using motion vectors. When bi-directional prediction is used, prediction is formed using an average of two predictions, a forward and backward prediction, as shown in FIG. 1.

FIG. 1 is a diagram illustrating an example of bi-directional prediction. The current block (Bc) is predicted based on backward prediction (Pb) and forward prediction (Pf). The current block (Bc) can be taken as the average prediction, which can be formed as Bc=(Pb+Pf)/2. But using such bi predictions (e.g., averaging the two predictions) may not give the best prediction. In some implementations, the current subject matter includes using a weighted average of the forward and backward predictions. In some implementations, the current subject matter can provide for improved predicted blocks and improved use of reference frames to improve compression.

In some implementations, multi-level prediction can include, for a given block, Bc, in the current picture being coded, two predictors Pi and Pj can be identified using a motion estimation process. For example, a prediction Pc=(Pi+Pj)/2 can be used as the predicted block. A weighted prediction can be computed as Pc=α Pi+(1−α)Pj where α={¼, −⅛}. When such weighted prediction used, weights can be signaled in the video bit stream. Limiting the choice to two weights reduces the overhead in the bit stream and effectively reduces the bitrate and improves compression.

In some implementations, adaptive weights can be based on reference picture distances. In such case the weights can be determined as: Bc=αP_{I}+βR_{J}. In some implementations, β=(1−α). In some implementations, N_{I} and N_{J} can include distances of reference frames I and J. The factors α and β can be determined as function of frame distances. For example, α=α₀× (N_{I})/(N_{I}+N_{J}); β=(1−α).

In some implementations, adaptive weights can be adopted from neighboring blocks when the current block adopts the motion information from the neighboring block. For example, when the current block is in merge mode and identifies a spatial or temporal neighbor, in addition to adopting the motion information, weights can be adopted as well.

In some implementations, the scaling parameters α, β can vary per block and lead to additional overhead in the video bit stream. In some implementations, bit stream overhead can be reduced by using the same value of a for all sub blocks of a given block. Further constraints can be placed where all blocks of a frame use the same value of a and such value is signaled only once at a picture level header such as the picture parameter set. In some implementations, the prediction mode used can be signaled by signaling new weights at block level, use weights signaled at frame level, adopt weights from neighboring blocks in a merge mode, and/or adaptively scaling weights based on reference frame distances.

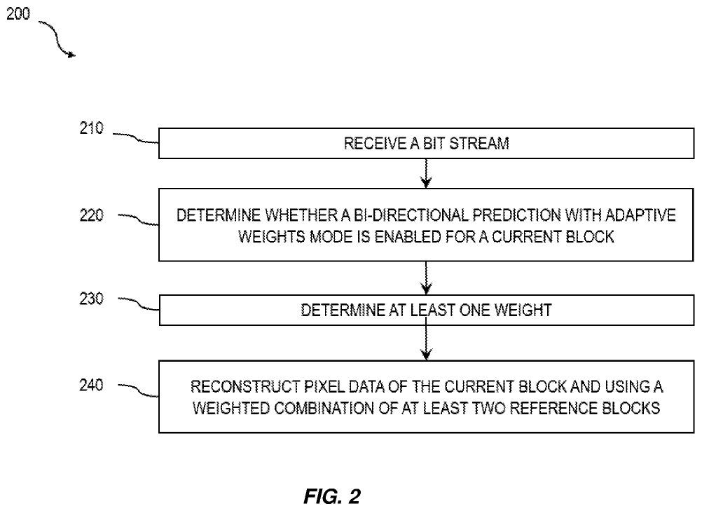

FIG. 2 is a process flow diagram illustrating an example decoding process 200 of bi-directional prediction with adaptive weights.

At 210, a bit stream is received. Receiving the bit stream can include extracting and/or parsing a current block and associated signaling information from the bit stream.

At 220, whether a bi-directional prediction with adaptive weights mode is enabled for the current block. In some implementations, the bit stream can include a parameter indicating whether bi-directional prediction with adaptive weights mode is enabled for the block. For example, a flag (e.g., sps_bcw_enabled_flag) can specify whether bi-prediction with coding unit (CU) weights can be used for inter prediction. If sps_bcw_enabled_flag is equal to 0, the syntax can be constrained such that no bi-prediction with CU weights is used in the coded video sequence (CVS), and bcw_idx is not present in coding unit syntax of the CVS. Otherwise, (e.g., sps_bcw_enabled_flag is equal to 1), bi-prediction with CU weights can be used in the CVS.

At 230, at least one weight can be determined. In some implementations, determining at least one weight can include determining an index into an array of weights; and accessing the array of weights using the index. The index can vary between blocks, and can be explicitly signaled in the bitstream or inferred.

For example, an index array bcw_idx[x0][y0] can be included in the bit stream and can specify the weight index of bi-prediction with CU weights. The array indices x0, y0 specify the location (x0, y0) of the top-left luma sample of the current block relative to the top-left luma sample of the picture. When bcw_idx[x0][y0] is not present, it can be inferred to be equal to 0.

In some implementations, the array of weights can include integer values, for example, the array of weights can be {4, 5, 3, 10, −2}. Determining a first weight can include setting a first weight variable w1 to an element of the array specified by the index and determining the second weight can include setting a second weight variable w0 equal to the value minus the first weight variable w1. For example, determining the first weight and determining the second weight can be performed according to: setting a variable w1 equal to bcwWLut[bcwIdx] with bcwWLut[k]={4, 5, 3, 10, −2} and setting variable w0 equal to (8−w1).

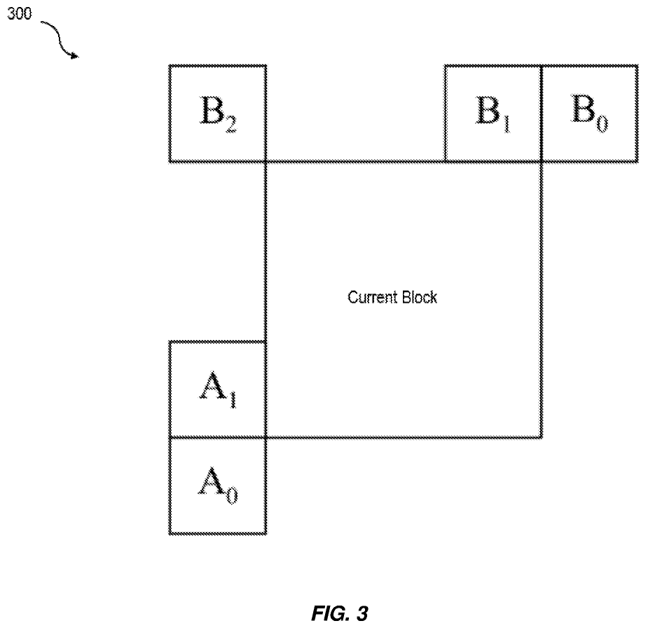

Determining the index can include adopting the index from a neighboring block during a merge mode. For example, in merge mode, motion information for the current block is adopted from a neighbor. FIG. 3 illustrates example spatial neighbors (A0, A1, B0, B1, B2) for a current block (where each of A0, A1, B0, B1, B2 indicates the location of the neighboring spatial block).

Adopting the index from the neighboring block during merge mode can include determining a merge candidate list containing spatial candidates and temporal candidates; selecting, using a merge candidate index included in the bistream, a merge candidate from the merge candidate list; and setting a value of the index to a value of an index associated with the selected merge candidate.

Referring again to FIG. 2, at 240, pixel data of the current block can be reconstructed using a weighted combination of at least two reference blocks. The at least two reference blocks can include a first block of prediction samples from a previous frame and a second block of prediction samples from a future frame.

Reconstructing can include determining a prediction and combining the prediction with a residual. For example, in some implementations, the prediction sample values can be determined as follows.

pbSamples[x][y]=Clip3(0,(1<<bitDepth)−1,(w0*predSamplesU[x][y]+w1*predSamplesL1[x][y]+offset3)>>>(shift2+3))

where pbSambles [x] [y] are prediction pixel values, x and y are luma locations,

$$Clip 3 ( x , y , z ) = \{ \begin{matrix}x ; & z < x \\ y ; & z > y \\ z ; & other wise\end{matrix}$$

<< is an arithmetic left shift of a two's complement integer representation by binary digits, predSamplesL0 is a first array of pixel values of a first reference block of the at least two reference blocks, predSamplesL1 is a second array of pixel values of a second reference block of the at least two reference blocks, offset3 is an offset value, and shift2 is a shift value.

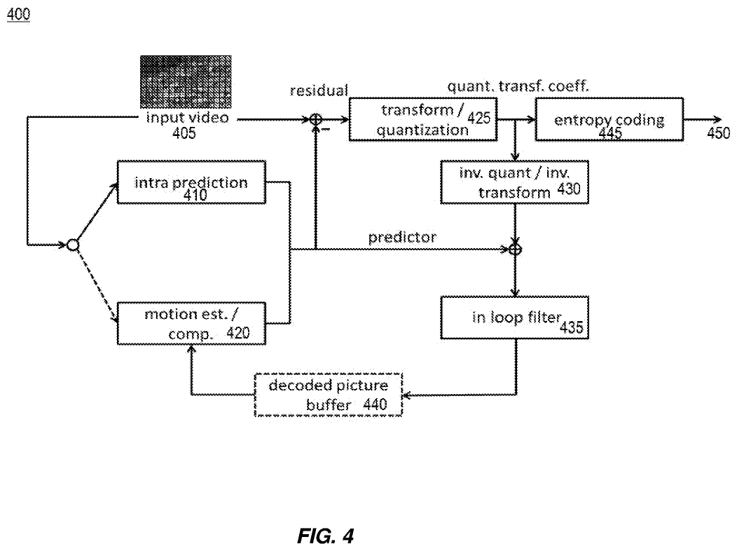

FIG. 4 is a system block diagram illustrating an example video encoder 400 capable of performing bi-directional prediction with adaptive weights. The example video encoder 400 receives an input video 405, which can be initially segmented or dividing according to a processing scheme, such as a tree-structured macro block partitioning scheme (e.g., quad-tree plus binary tree). An example of a tree-structured macro block partitioning scheme can include partitioning a picture frame into large block elements called coding tree units (CTU). In some implementations, each CTU can be further partitioned one or more times into a number of sub-blocks called coding units (CU). The final result of this portioning can include a group of sub-blocks that can be called predictive units (PU). Transform units (TU) can also be utilized.

The example video encoder 400 includes an intra prediction processor 415, a motion estimation/compensation processor 420 (also referred to as an inter prediction processor) capable of supporting bi-directional prediction with adaptive weights, a transform/quantization processor 425, an inverse quantization/inverse transform processor 430, an in-loop filter 435, a decoded picture buffer 440, and an entropy coding processor 445. In some implementations, the motion estimation/compensation processor 420 can perform bi-directional prediction with adaptive weights. Bit stream parameters that signal bi-directional prediction with adaptive weights mode and related parameters can be input to the entropy coding processor 445 for inclusion in the output bit stream 450.

In operation, for each block of a frame of the input video 405, whether to process the block via intra picture prediction or using motion estimation/compensation can be determined. The block can be provided to the intra prediction processor 410 or the motion estimation/compensation processor 420. If the block is to be processed via intra prediction, the intra prediction processor 410 can perform the processing to output the predictor. If the block is to be processed via motion estimation/compensation, the motion estimation/compensation processor 420 can perform the processing including use of bi-directional prediction with adaptive weights to output the predictor.

A residual can be formed by subtracting the predictor from the input video. The residual can be received by the transform/quantization processor 425, which can perform transformation processing (e.g., discrete cosine transform (DCT)) to produce coefficients, which can be quantized. The quantized coefficients and any associated signaling information can be provided to the entropy coding processor 445 for entropy encoding and inclusion in the output bit stream 450. The entropy encoding processor 445 can support encoding of signaling information related to bi-directional prediction with adaptive weights. In addition, the quantized coefficients can be provided to the inverse quantization/inverse transformation processor 430, which can reproduce pixels, which can be combined with the predictor and processed by the in loop filter 435, the output of which is stored in the decoded picture buffer 440 for use by the motion estimation/compensation processor 420 that is capable of supporting bi-directional prediction with adaptive weights.

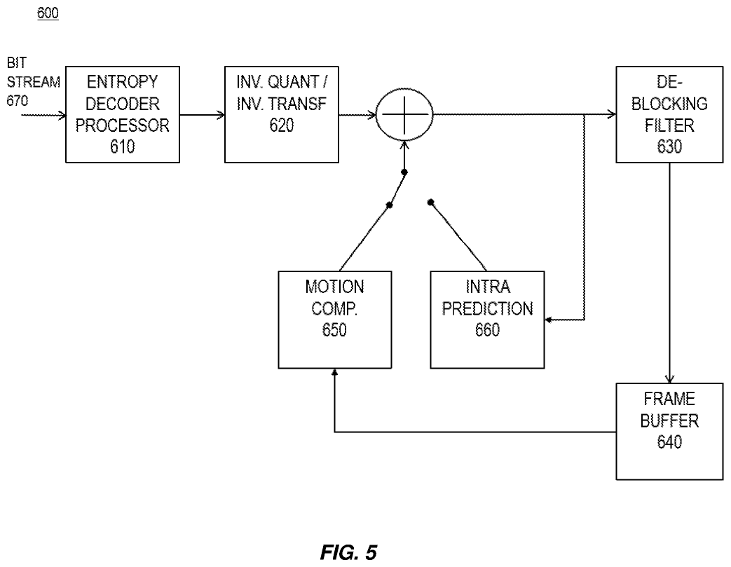

FIG. 5 is a system block diagram illustrating an example decoder 600 capable of decoding a bit stream 670 using bi-directional prediction with adaptive weights. The decoder 600 includes an entropy decoder processor 610, an inverse quantization and inverse transformation processor 620, a deblocking filter 630, a frame buffer 640, motion compensation processor 650 and intra prediction processor 660. In some implementations, the bit stream 670 includes parameters that signal a bi-directional prediction with adaptive weights. The motion compensation processor 650 can reconstruct pixel information using bi-directional prediction with adaptive weights as described herein.

In operation, bit stream 670 can be received by the decoder 600 and input to entropy decoder processor 610, which entropy decodes the bit stream into quantized coefficients. The quantized coefficients can be provided to inverse quantization and inverse transformation processor 620, which can perform inverse quantization and inverse transformation to create a residual signal, which can be added to the output of motion compensation processor 650 or intra prediction processor 660 according to the processing mode. The output of the motion compensation processor 650 and intra prediction processor 660 can include a block prediction based on a previously decoded block. The sum of the prediction and residual can be processed by deblocking filter 630 and stored in a frame buffer 640. For a given block, (e.g., CU or PU), when the bit stream 670 signals that the mode is bi-directional prediction with adaptive weights, motion compensation processor 650 can construct the prediction based on the bi-directional prediction with adaptive weights scheme described herein.

Although a few variations have been described in detail above, other modifications or additions are possible. For example, in some implementations, a quadtree plus binary decision tree (QTBT) can be implemented. In QTBT, at the Coding Tree Unit level, the partition parameters of QTBT are dynamically derived to adapt to the local characteristics without transmitting any overhead. Subsequently, at the Coding Unit level, a joint-classifier decision tree structure can eliminate unnecessary iterations and control the risk of false prediction. In some implementations, bi-directional prediction with adaptive weights based on reference picture distances can be available as an additional option available at every leaf node of the QTBT.

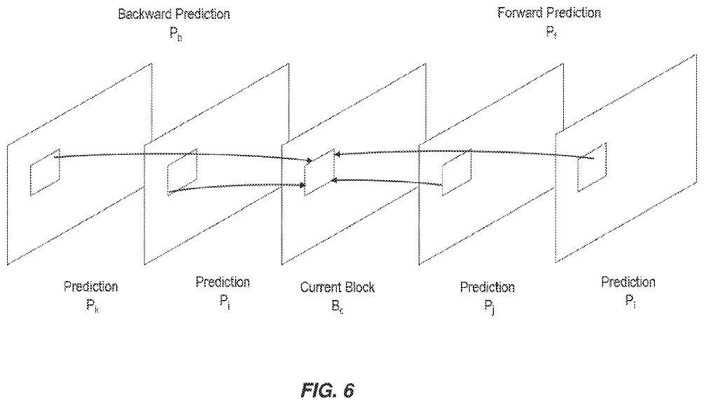

In some implementations, weighted prediction can be improved using multi-level prediction. In some examples of this approach, two intermediate predictors can be formed using predictions from multiple (e.g., three, four, or more) reference pictures. For example, two intermediate predictors P_{U} and P_{KL}, can be formed using predictions from reference pictures I, J, K, L, as shown in FIG. 6. FIG. 6 is a block diagram illustrating an example multi-level prediction with adaptive weights approach according to some implementations of the current subject matter. Current block (Bc) can be predicted based on two backward predictions (Pi and Pk) and two forward predictions (Pj and Pl).

Two predications Pij and Pkl can be calculated as: P_{IJ}=αP_{I}+(1−α)P_{J}, and Pₖₗ=αP_{K}+(1−α)P_{L}.

The final prediction for the current block Bc can be computed using a weighted combination of P_{IJ} and P_{KL}, For example, B_{c}=αP_{IJ}+(1−α)P_{KL}.

In some implementations, the scaling parameters α can vary per block and lead to additional overhead in the video bitstream. In some implementations, bitstream overhead can be reduced by using the same value of α for all sub blocks of a given block. Further constraints can be placed where all blocks of a frame use the same value of a and such value is signaled only once at a picture level header such as the picture parameter set. In some implementations, the prediction mode used can be signaled by signaling new weights at block level, use weights signaled at frame level, adopting weights from neighboring blocks in merge mode, and/or adaptively scaling weights based on reference frame distances.

In some implementations, multi-level bi-prediction can be implemented at the encoder and/or the decoder, for example, the encoder of FIG. 4 and the decoder of FIG. 5. For example, a decoder can receive a bitstream, determine whether a multi-level bi-directional prediction mode is enabled, determine at least two intermediate predictions, and reconstruct pixel data of a block and using a weighted combination of the at least two intermediate predictions.

In some implementations, additional syntax elements can be signaled at different hierarchy levels of the bit stream.

The current subject matter can apply to affine control point motion vector merging candidates, where two or more control points are utilized. Weight can be determined for each of the control points (e.g., 3 control points)

The subject matter described herein provides many technical advantages. For example, some implementations of the current subject matter can provide for bi-directional prediction with adaptive weights that increases compression efficiency and accuracy.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A video decoding method comprising:
receiving a bit stream;
determining whether a bi-directional prediction with adaptive weights mode is enabled for a current block;
determining at least one weight; and
reconstructing pixel data of the current block and using a weighted combination of at least two reference blocks.

2. The video decoding method of claim 1, wherein the bit stream includes a parameter indicating whether the bi-directional prediction with adaptive weights mode is enabled for the block.

3. The video decoding method of claim 1, wherein the bi-directional prediction with adaptive weights mode is signaled in the bit stream.

4. The video decoding method of claim 1, wherein determining at least one weight includes determining an index into an array of weights; and accessing the array of weights using the index.

5. The video decoding method of claim 1, wherein determining at least one weight includes:
determining a first distance from a current frame to a first reference frame of the at least two reference blocks;
determining a second distance from the current frame to a second reference frame of the at least two reference blocks; and
determining the at least one weight based on the first distance and the second distance.

6. The video decoding method of claim 5, wherein determining the at least one weight based on the first distance and the second distance is performed according to:
w1=α0×(N_{I})/(N_{I}+N_{J});
w0=(1−w1);
wherein w1 is a first weight, w0 is a second weight, α₀ is a predetermined value; N_{I} is the first distance and N_{J} is the second distance.

7. The video decoding method of claim 1, wherein determining at least one weight includes:
determining a first weight by at least determining an index into an array of weights and accessing the array of weights using the index; and
determining a second weight by at least subtracting the first weight from a value.

8. The video decoding method of claim 7, wherein the array includes integer values including {4, 5, 3, 10, −2}.

9. The video decoding method of claim 7, wherein determining the first weight includes setting a first weight variable w1 to an element of the array specified by the index;
wherein determining the second weight includes setting a second weight variable w0 equal to the value minus the first weight variable.

10. The video decoding method of claim 9, wherein determining the first weight and determining the second weight is performed according to:
setting a variable w1 equal to bcwWLut[bcwIdx] with bcwWLut[k]={4, 5, 3, 10, −2}; and
setting a variable w0 equal to (8−w1);
wherein bcwIdx is the index, and k is a variable.

11. The video decoding method of claim 10, wherein the weighted combination of the at least two reference blocks is computed according to pbSamples[x][y]=Clip3(0,(1<<bitDepth)−1,(w0*predSamplesL0[x][y]+w1*predSamplesL1[x][y]+offset3)
>>(shift2+3))
where pbSamples [x] [y] are prediction pixel values, x and y are luma locations,
<< is an arithmetic left shift of a two's complement integer representation by binary digits,
predSamplesL0 is a first array of pixel values of a first reference block of the at least two reference blocks,
predSamplesL1 is a second array of pixel values of a second reference block of the at least two reference blocks,
$$Clip 3 ( x , y , z ) = \{ \begin{matrix}x ; & z < x \\ y ; & z > y \\ z ; & other wise\end{matrix}$$
offset3 is an offset value, and
shift2 is a shift value.

12. The video decoding method of claim 7, wherein determining the index includes adopting the index from a neighboring block during a merge mode.

13. The video decoding method of claim 12, wherein adopting the index from the neighboring block during merge mode includes determining a merge candidate list containing spatial candidates and temporal candidates, selecting, using a merge candidate index included in the bit stream, a merge candidate from the merge candidate list, and setting a value of the index to a value of an index associated with the selected merge candidate.

14. The video decoding method of claim 1, wherein the at least two reference blocks include a first block of prediction samples from a previous frame and a second block of prediction samples from a subsequent frame.

15. The video decoding method of claim 1, wherein reconstructing pixel data includes using an associated motion vector contained in the bit stream.

16. (canceled)

17. The video decoding method of claim 1, wherein the current block forms part of a quadtree plus binary decision tree.

18. The video decoding method of claim 1, wherein the current block is a coding tree unit, a coding unit, or a prediction unit.

19-20. (canceled)

21. A video decoder comprising:
an entropy decoder which entropy decodes a bit stream into quantized coefficients;
an inverse quantization and inverse transformation processor which performs inverse quantization and inverse transformation of the quantized coefficients to create a residual signal for a current block;
a motion compensation processor which create a prediction signal using a weighted combination of at least two reference blocks when a parameter included in the bit stream indicates that a bi-directional prediction with adaptive weights mode is enabled for the current block; and
an adder which adds the prediction signal to the residual signal.

22. The video decoder of claim 21, wherein the weighted combination of at least two reference blocks is weighted with a first weight which is determined by at least determining an index into an array of weights and accessing the array of weights using the index, and a second weight which is determined by at least subtracting the first weight from a value.

23. A video encoding method comprising;
creating a predictor, for a block divided from a frame of an input video, using a weighted combination of at least two reference blocks on a basis of bi-directional prediction with adaptive weights;
subtracting the predictor from the block to obtain a residual;
performing transformation and quantization to create quantized coefficients from the residual;
generating a bit stream which includes the quantized coefficients by entropy encoding.

24. The video encoding method of claim 23, wherein the weighted combination of at least two reference blocks is weighted with a first weight and a second weight,
the first weight is obtained from an array of weights and the second weight is determined by subtracting the first weight from a value, and
an index into the array of weights which specifies the first weight is included in the bit stream.

25. A video encoder comprising:
a motion compensation processor which creates a predictor, for a block divided from a frame of an input video, using a weighted combination of at least two reference blocks on a basis of bi-directional prediction with adaptive weights;
a subtractor which subtracts the predictor from the block to create a residual;
a transformation and quantization processor which creates quantized coefficients from the residual;
an entropy encoder which generates a bit stream including the quantized coefficients.

26. The video encoder of claim 25, wherein the weighted combination of at least two reference blocks is weighted with a first weight and a second weight,
the first weight is obtained from an array of weights and the second weight is determined by subtracting the first weight from a value, and
an index into the array of weights which specifies the first weight is included in the bit stream.
